(19) United States
(12) Patent Application Publication
(10) Pub. No.: US 2008/0283268 A1
(43) Pub. Date: Nov. 20, 2008

(54) Method for Stopping Water of Earth Wire and Earth Wire

(75) Inventors: Kennji Iwasaki, Tochigi (JP); Yoshiharu Ohashi, Aichi (JP); Muneaki Kanou, Aichi (JP)

Correspondence Address: AKERMAN SENTERFITT, P.O. BOX 3188, WEST PALM BEACH, FL, 33402-3188, US

(73) Assignees: Toagosei Co., Ltd, Tokyo (JP); Yazaki Corporation, Tokyo (JP)

(21) Appl. No.: 11/997,206

(22) PCT Filed: Jul. 28, 2006
(86) PCT No.: PCT/JP2006/314985

§ 371 Date: Jul. 9, 2008

(30) Foreign Application Priority Data
Jul. 29, 2005 (JP) 2005-221568

(51) Int. Cl. H02G 15/02; B05D 3/02; B05D 3/06

(52) U.S. Cl. 174/78; 427/117; 427/558

(57) ABSTRACT

In a ground cable to be applied to an on-vehicle wiring harness or the like, the aim is to make it easy and simple to conduct the waterproofing work.

A first sealant 6 of the UV-cure type having as a contact angle with respect to the bare conductor 1a of the ground cable 1 an acute one and a viscosity of 15-500 mPa·s is delivered by drops onto the bare conductor. The first sealant 6 is delivered by drops onto a second sealant 7. The first and second sealants 6 and 7 are irradiated by ultraviolet rays. This permits the first sealant 6 to, without the need to suck-decompress the interior of the ground cable 1, by dint of capillarity, spontaneously permeate into the cable core 1b of the ground cable 1 to be then cured. Even in case where a ground terminal 2 has a pair of ground cables 1 crimped thereonto, each ground cable 1 permits an adequate amount of the sealant 6 to, with ease, permeate it. In place of the first sealant 6 of the UV-cure type, the first sealant 6 of the light cure type or, by the same token, of the chemical reaction type may also be used. An adhesive having a composite cure function (that is, an adhesive having two or more cure functions concurrently), such as a light curing instant adhesive or the like, may also be used.

### TECHNICAL FIELD

This invention relates to a method of waterproofing a ground cable and a ground cable per se, both suitable for application to an on-vehicle wiring harness or the like.

### TECHNICAL BACKGROUND

FIG. 11 is a plan view illustrative of one example of a prior art ground cable.

In general, this type of ground cable is designed such that, with its end portion having a ground terminal fixed thereto and with the terminal being in a state of being exposed to the exterior, it is connected to an adequate grounding location (for example, vehicle body). Due to this, entering from the ground cable end portion and passing along the cable inside, moisture tends to easily reach inside. Therefore, in case where the end portion located on the opposite side to a ground terminal has an electronic control section provided thereat, this section has the risk of being reached by moisture, thereby resulting in its normal operation being hindered. This makes it necessary for a ground cable to be subjected to a waterproofing process.

In the past, as such waterproofing method has been proposed one in which, as shown in FIG. 11, the respective connection portion of a ground cable 1 and a ground terminal 2 has a fluid waterproofing agent 8 delivered thereonto by drops and, at the same time, the interior of the ground cable 1 is suck-decompressed to thereby cause the waterproofing agent 8 to permeate the ground cable 1 (for example, refer to patent document 1).

### Patent Document 1: Japanese Patent Publication No. 2004-355851

### DISCLOSURE OF THE INVENTION

### Problems to Be Solved by the Invention

But, this prior art method has the following inconveniences.

First, the act of suck-decompressing the interior of the ground cable 1 entails an extra labor. This makes the waterproofing work cumbersome.

Second, in case where the ground terminal 2 has a pair of ground cables 1 crimped thereonto, the act of making an adequate amount of the waterproofing agent 8 permeate each ground cable 1 is accompanied by some difficulty.

The object of this invention is to provide a method of waterproofing a ground cable and a ground cable per se to make it possible to overcome the above inconveniences.

### Means for Solving the Problem

First, the invention of claim 1 relates to a method of waterproofing a ground cable. The method comprises: a sealing step of supplying a chemical reaction type sealant to a bare conductor of a ground cable, the sealant having as a contact angle an acute one with respect to the bare conductor; and a curing step of curing the sealant.

The invention of claim 2 relates to a method of waterproofing a ground cable in which the sealant has a viscosity of 15-500 mPa·s.

The invention of claim 3 relates to a method of waterproofing a ground cable in which the sealing step has the ground cable being inclined such that a ground terminal is located above.

The invention of claim 4 relates to a method of waterproofing a ground cable in which the sealant is of the light cure type.

The invention of claim 5 relates to a method of waterproofing a ground cable in which the sealant is of the UV-cure type.

The invention of claim 6 relates to a method of waterproofing a ground cable in which the sealant is an adhesive having a composite cure function.

The invention of claim 7 relates to a method of waterproofing a ground cable in which the sealant is a light curing instant adhesive, light and anaerobic curing adhesive or light curing and thermosetting adhesive.

The invention of claim 8 relates to a ground cable waterproofed by the method of any one of claims 1-7.

### ADVANTAGEOUS EFFECT OF THE INVENTION

According to this invention, the cable core of a ground cable has a sealant, by dint of capillarity, spontaneously permeate it. This makes the waterproofing work easy and simple.

Even in case where a ground terminal has a pair of ground cables crimped thereonto, each ground cable permits an adequate amount of sealant to, with ease, permeate it.

### BRIEF DESCRIPTION OF THE DRAWINGS

FIG. 1 is a perspective view illustrative of a first embodiment of a ground cable according to this invention.

FIG. 2 is a plan view of the ground cable shown in FIG. 1.

FIG. 3 is a front view illustrative of the step of crimping a terminal in one embodiment of a method of waterproofing a ground cable according to this invention.

FIG. 4 is a front view illustrative of the step of placing a cable in one embodiment of a method of waterproofing a ground cable according to this invention.

FIG. 5 is a front view illustrative of a first sealing step in one embodiment of a method of waterproofing a ground cable according to this invention.

FIG. 6 is a front view illustrative of a curing state of a first sealant.

FIG. 7 is a front view illustrative of a second sealing step in one embodiment of a method of waterproofing a ground cable according to this invention.

FIG. 8 is a front view illustrative of a curing state of a second sealant.

FIG. 9 is a front view illustrative of a UV-irradiating step in one embodiment of a method of waterproofing a ground cable according to this invention.

FIG. 10 is a front view illustrative of a dismounting step in one embodiment of a method of waterproofing a ground cable according to this invention.

FIG. 11 is a plan view illustrative of a conventional ground cable.

### EXPLANATION OF REFERENCES

1: ground cable
1a: bare conductor
1b: cable core
1c: insulating coating
6: first sealant (sealant)
7: second sealant (sealant)
8: waterproofing agent
9: jig
α: angle of inclination

### BEST MODE FOR CARRYING OUT THE INVENTION

Hereinafter, embodiments of this invention will be described with reference to the drawings.

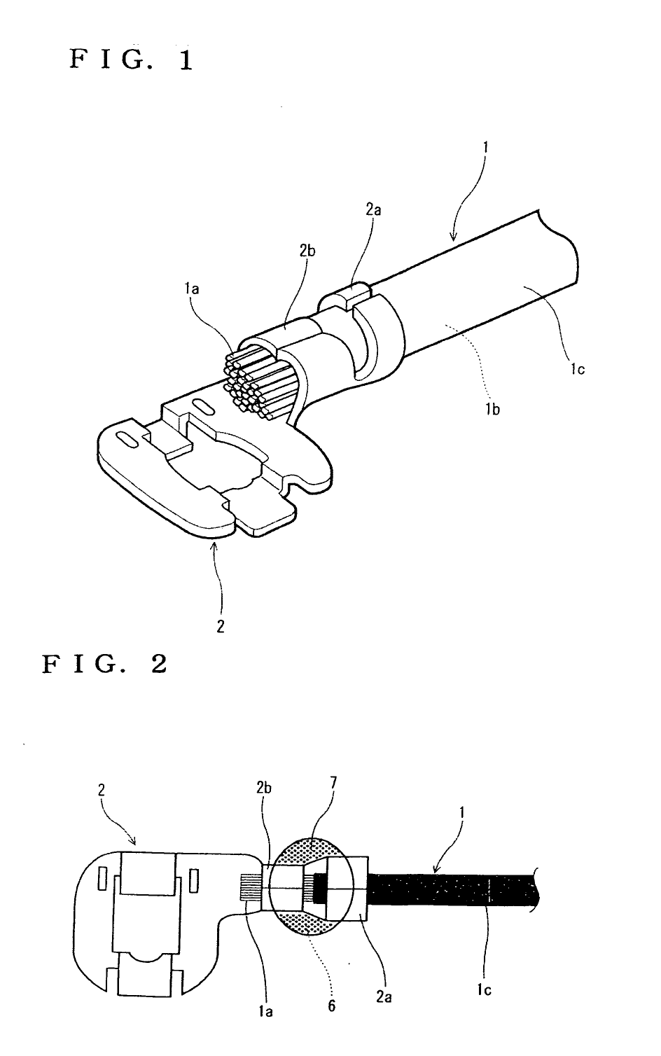

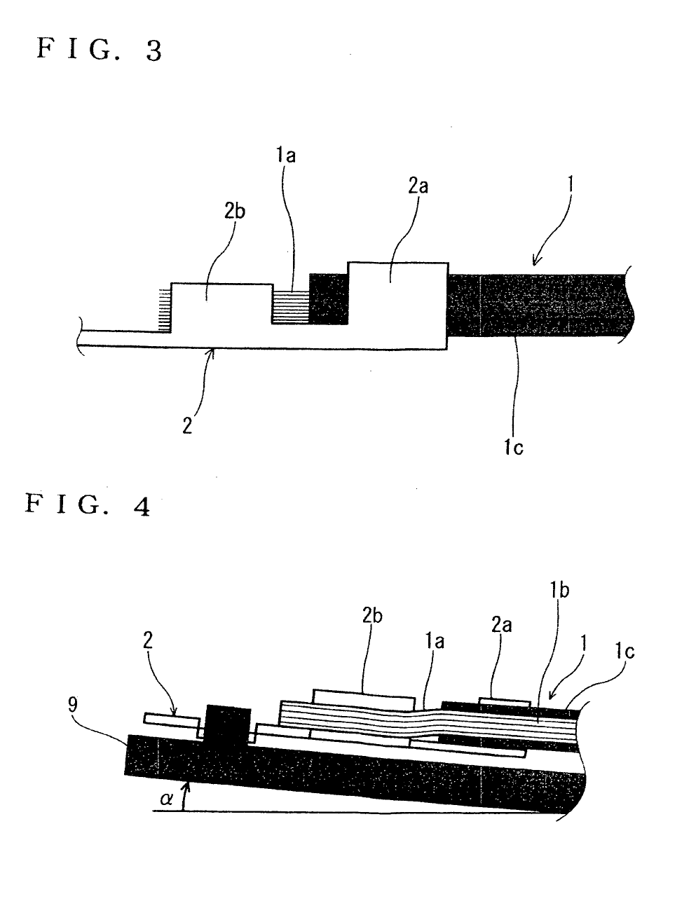

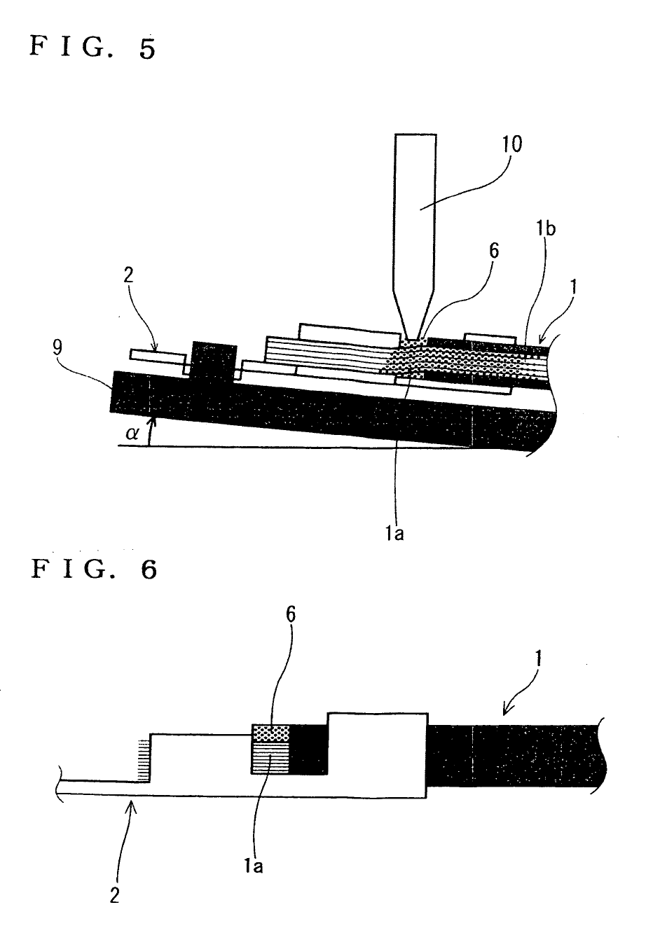

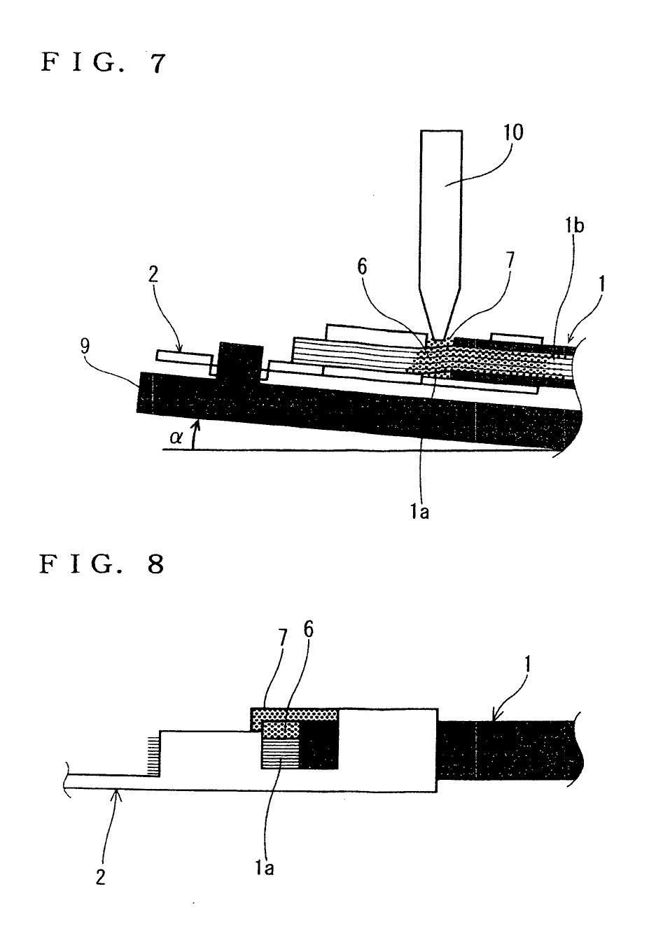

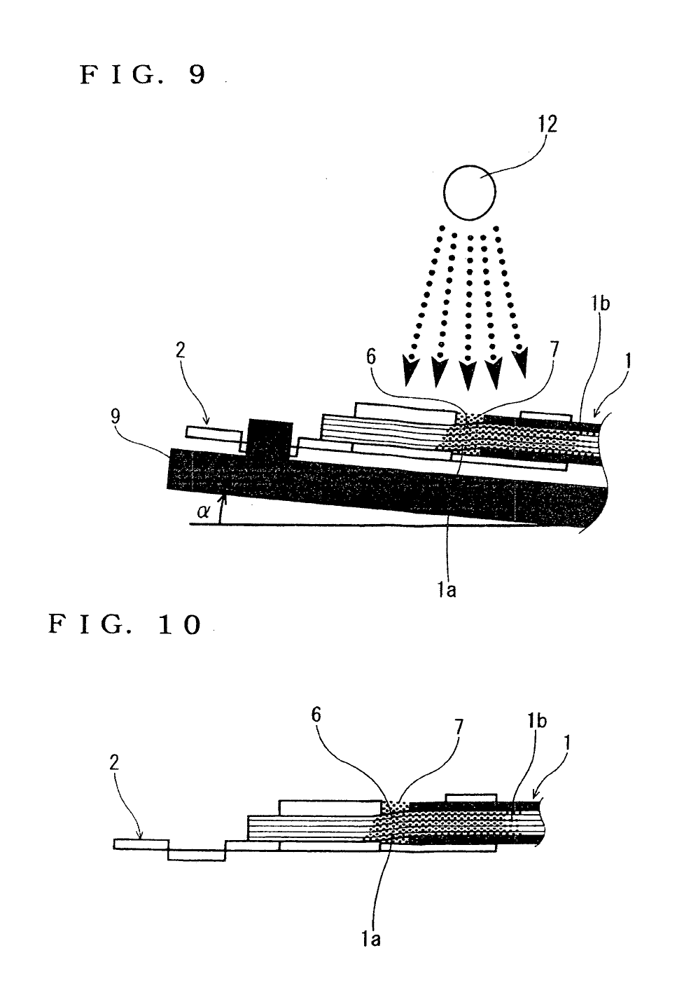

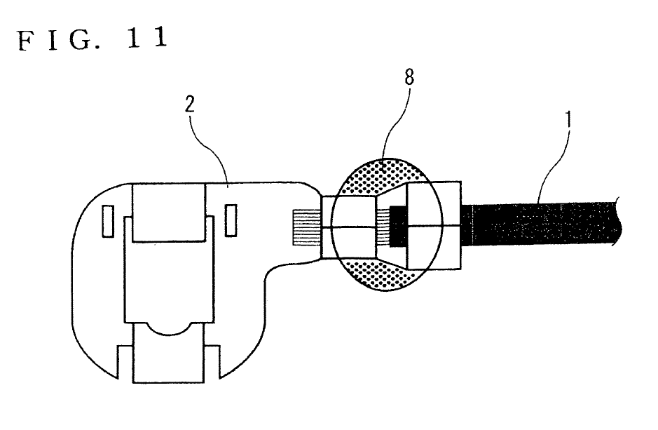

FIG. 1 is a perspective view illustrative of a first embodiment of a ground cable according to this invention; FIG. 2 is a plan view of the ground cable shown in FIG. 1; FIG. 3 is a front view illustrative of the step of crimping a terminal in one embodiment of a method of waterproofing a ground cable according to this invention; FIG. 4 is a front view illustrative of the step of placing a cable in one embodiment of a method of waterproofing a ground cable according to this invention; FIG. 5 is a front view illustrative of a first sealing step in one embodiment of a method of waterproofing a ground cable according to this invention; FIG. 6 is a front view illustrative of a curing state of a first sealant; FIG. 7 is a front view illustrative of a second sealing step in one embodiment of a method of waterproofing a ground cable according to this invention; FIG. 8 is a front view illustrative of a curing state of a second sealant; FIG. 9 is a front view illustrative of a UV-irradiating step in one embodiment of a method of waterproofing a ground cable according to this invention; and FIG. 10 is a front view illustrative of a dismounting step in one embodiment of a method of waterproofing a ground cable according to this invention.

Ground cable 1, as shown in FIG. 1, has a cable core 1b made up of copper wire. The cable core 1b has insulating coating 1c provided therearound. The end portion of the cable core 1b has the cable core 1b exposed, thereby resulting in a bare conductor 1a being formed.

The end portion of the ground cable 1, as shown in FIG. 1, has a ground terminal 2 crimped thereonto. The ground cable 1 and the ground terminal 2 have a connection portion in between, which, as shown in FIG. 2, has a first sealant 6 being affixed thereonto for coating the bare conductor 1a at the end portion of the ground cable 1 and a second sealant 7 being affixed thereonto for coating the first sealant 6.

The aim of waterproofing the end portion of the ground cable 1, that is, its connection portion with respect to the ground terminal 2, is achieved by the following procedures.

First, as shown in FIG. 3, the end portion of the ground cable 1 has the ground terminal 2 crimped thereonto. For this purpose, the forward crimp leg 2a of the ground terminal 2 is caulked to thereby grip the insulation coating 1c of the ground cable 1, and, at the same time, the backward crimp leg 2b of the ground terminal 2 is caulked to be electrically connected to the bare conductor 1a of the ground cable 1.

Next, as shown in FIG. 4, with the ground terminal 2 thus having been crimped onto the ground cable 1, the cable 1 is placed on a jig 9. Here, the jig 9 is inclined by a predetermined angle of inclination at so as for the ground terminal 2 to be located above. This inclination angle α is desirably within the range of 5-30°. The reason is that if the inclination angle at is less than 5°, the act of inclining the jig 9 produces a lessened effect and that if the inclination angle α is in excess of 30°, then on the occasion of delivering a first sealant 1 as described later, the problem of the first sealant 6 drooping down along the outer side of the insulating coating 1c of the ground cable 1 arises easily.

Next, as shown in FIG. 5, drops of a first sealant 6 are supplied from a nozzle 10 onto the bare conductor 1a of the ground cable 1. As the first sealant 6 is used a UV-cure type one having as a contact angle with respect to the bare conductor 1a of the ground cable 1 an acute one (for example, 19.5°), a viscosity of 15-500 mPa·s, and a surface tension of 0.0292 N/m (29.2 dyne/cm). Here, the first sealant 6, because of having as a contact angle with respect to the bare conductor 1a of the ground cable 1 an acute one and a high wettability, is subject to capillarity so as to spontaneously be absorbed into the cable core 1b of the ground cable 1. Further, the first sealant 6, due to exerting at its viscosity of 15-500 mPa·s an adequate viscosity, comes to a standstill at the point when the first sealant 6 permeate into the cable core 1b of the ground cable 1 to a certain degree. In the end, the first sealant 6, as shown in FIGS. 5 and 6, turns out to be cured in a state of simultaneously permeating the cable core 1b of the ground cable 1 while having coated the bare conductor 1a. Incidentally, the ground cable 1 is inclined such that the ground terminal 2 is located above, which permits one to prevent the event from occurring of the first sealant 6 drooping down toward the side having the ground terminal 2 located therein. Incidentally, the inventive viscosity refers to measurements at 25° C. obtained by using an E type viscometer (cone and plate viscometer)

Next, the aim of protecting the first sealant 6, as shown in FIG. 7, is achieved by supplying drops of a second sealant 7 from nozzle 10 onto the first sealant 6. As this second sealant 7 is used one having a viscosity higher than that of the first sealant 6 (for example, one having a viscosity of 1000-5000 mPa·s). This causes the second sealant 7, as shown in FIG. 8, to arrive at a state of coating the first sealant 6. At this point, the second sealant 7, due to having a higher viscosity than the first sealant 6, remains staying on the first sealant 6, which prevents the adverse event from occurring of flowing outwardly up to within the surrounding area.

Next, as shown in FIG. 9, ultraviolet rays are irradiated from a UV lamp 12 onto the first sealant 6 and second sealant 7. This causes the first sealant 6, in a state of having permeated into the cable core 1b of the ground cable 1, to be UV-cured. On the other hand, the second sealant 7, in a state of having coated the first sealant 6, is likewise UV-cured.

Finally, as shown in FIG. 10, the ground cable 1 is removed from the jig 9.

At this point, the work of waterproofing the end portion of the ground cable 1 is finished.

Thus, the first sealant 6, without the need to suck-decompress the interior of the ground cable 1, can, by dint of capillarity, spontaneously permeate into the cable core 1b of the ground cable 1, which makes the waterproofing work easy and simple.

Even with the ground terminal 2 having a pair of ground cables 1 crimped thereonto, each ground cable 1 permits an adequate amount of the first sealant 6 to easily permeate thereinto.

Incidentally, in the above embodiment, the case of using the first sealant 6 and second sealant 7 has been explained. But in the case of the necessity to protect the first sealant 6 being low, the second sealant 7 can be dispensed with. This makes it possible to reduce material cost of the second sealant 7 and alleviate the trouble of delivering drops of liquid.

Incidentally, in the above embodiment, the case of using the first sealant 6 of the UV-cure type has been described. But, so far as its contact angle with respect to the bare conductor 1a of the ground cable 1 is an acute one, it is not limited to the UV-cure type; rather, widely, the first sealant 6 of the light cure type may also be used. By the same token, it is not limited to the light cure type; rather, widely, the first sealant 6 of the chemical reaction type may also be used. Here, in addition to an adhesive having a single cure function, an adhesive having two or more cure functions concurrently (as used herein, this is referred to as an adhesive having a composite cure function) may be used as the first sealant 6 as well. As specific examples of an adhesive having a single cure function may be cited a thermosetting adhesive (for example, acrylic adhesive, epoxy adhesive, oxetan adhesive, etc.), a moisture curing adhesive (for example, silicone adhesive, modified silicone adhesive, etc.) or the like. As specific examples of an adhesive having a composite cure function may be cited a light curing instant adhesive, light and anaerobic curing adhesive (for example, acrylic adhesive, etc.), light curing and thermosetting adhesive (for example, acrylic adhesive, epoxy adhesive, oxetan adhesive, etc.)

An adhesive having a composite cure function, due to excelling in curability, permits the bare conductor 1a and cable core 1b of the ground cable 1 to be waterproofed uniformly in a short amount of time, which constitutes an advantage. Especially, a light curing instant adhesive or light and anaerobic curing adhesive has a short cure time and excels in productivity, which constitutes an advantage. Incidentally, in the case of using a light curing instant adhesive, the first sealant 6 having a contact angle with respect to the bare conductor 1a of the ground cable 1 of 25° or less is desirable. Instead of the UV lamp 12 being applied to irradiate ultraviolet rays for the purpose of UV-curing, a high pressure mercury lamp, metal halide lamp or the like may be applied to irradiate light for the purpose of light-curing.

### EMBODIMENT 1

Hereinafter, embodiment 1 of this invention (representing a case of using a first sealant of the UV-cure type), will be described.

A pair of ground cables having respectively a conductor cross sectional area of 0.5 mm² and 1.25 mm² were crimped onto a ground terminal. Subsequently, a first sealant (of the UV-cure type) having a viscosity of 15 mPa·s was delivered by drops in the amount of 25 microliters. And then, a second sealant having a viscosity of 5000 mPa·s was delivered by drops in the amount of 10 microliters. The condition for UV irradiation was made 100 mW/cm²×70 sec.

As a result, at the initial stage, waterproof property of 200 kPa (approx. 2 kgf/cm²) or more was exerted. Even after letting stand at temperature of 110° C. for the time period of 200 hours, waterproof property of 200 kPa was retained. The first sealant showed a suction height of, for each of the ground cables, 20 mm.

### EMBODIMENT 2

Hereinafter, embodiment 2 of this invention (representing a case of using as a first sealant a light curing instant adhesive) will be described.

A pair of ground cables having respectively a conductor cross sectional area of 0.5 mm² and 1.25 mm² were crimped onto a ground terminal. Subsequently, a first sealant (light curing instant adhesive) having a viscosity of 15 mPa·s was delivered by drops in the amount of 25 microliters. And then, a second sealant having a viscosity (light curing instant adhesive) of 5000 mPa·s was delivered by drops in the amount of 10 microliters. The condition for light irradiation is made 100 mW/cm² (365 nm)×70 sec.

As a result, at the initial stage, waterproof property of 200 kPa (approx. 2 kgf/cm²) or more was exerted. Even after letting stand at temperature of 110° C. for the time period of 200 hours, waterproof property of 200 kPa was retained. The first sealant showed a suction height of, for each of the ground cables, 20 mm.

### EMBODIMENT 3

Hereinafter, embodiment 3 of this invention (representing a case of using as a first sealant a light curing and thermosetting adhesive) will be described.

A pair of ground cables having respectively a conductor cross sectional area of 0.5 mm² and 1.25 mm² were crimped onto a ground terminal. Subsequently, a first sealant (light curing and thermosetting adhesive) having a viscosity of 200 mPa·s was delivered by drops in the amount of 15 microliters. Subsequently, for the time period of 100 mW/cm² (365 nm)×70 sec was light irradiated, followed by heat curing at 80° C. for the time period of 1 hour.

As a result, at the initial stage, waterproof property of 200 kPa (approx. 2 kgf/cm²) or more was exerted. Even after letting stand at temperature of 120° C. for the time period of 100 hours, waterproof property of 200 kPa was retained. The first sealant showed a suction height of, for each of the ground cables, 5 mm.

### INDUSTRIAL APPLICABILITY

This invention is widely applicable: for example, to an on-vehicle wiring harness or the like.

1. A method of waterproofing a ground cable comprising:
a sealing step of supplying a chemical reaction type sealant to a bare conductor of the ground cable, the sealant having as a contact angle an acute one with respect to the bare conductor; and
a curing step of curing the sealant.

2. The method of claim 1, wherein the sealant has a viscosity of 15-500 mPa·s.

3. The method of claim 1, wherein the sealing step:
the ground cable is inclined such that a ground terminal is located above.

4. The method of claim 1, wherein the sealant is of the light cure type.

5. The method of claim 1, wherein the sealant is of the UV-cure type.

6. The method of claim 1, wherein the sealant is an adhesive having a composite cure function.

7. The method of claim 1, wherein the sealant is a light curing instant adhesive, light and anaerobic curing adhesive or light curing and thermosetting adhesive.

8. A ground cable waterproofed by the method of claim 1.
